(19) United States
(12) Patent Application Publication
(10) Pub. No.: US 2008/0208611 A1
(43) Pub. Date: Aug. 28, 2008

(54) Addressing method for freight, cargo and mail

(76) Inventor: Kevin W. Krooss, Centerport, NY (US)

Correspondence Address: Thomas A. O'Rourke;Bodner & O'Rourke, 425 Broadhollow Road, Melville, NY, 11747, US

(21) Appl. No.: 12/072,505

(22) Filed: Feb. 26, 2008

Related U.S. Application Data
(60) Provisional application No. 60/903,502, filed on Feb. 26, 2007.

(51) Int. Cl. G06Q 99/00

(52) U.S. Cl. 705/1

(57) ABSTRACT

A delivery system for delivery of an item to an actual physical location by means of a virtual address selected by a recipient, is provided. The virtual address is associated with the actual physical address by means of a database.

### CROSS-REFERENCE TO RELATED APPLICATIONS

This application claims priority on provisional U.S. Application Ser. No. 60/903,502 filed on Feb. 26, 2007, the disclosures of which are incorporated herein by reference.

### BACKGROUND

1. Field of Invention

This invention relates to improved methods of addressing including but not limited to the addressing of cargo, freight and mail items, and specifically an improved means of addressing such items for delivery by a shipper postal administration or other delivery means.

2. Description of Prior Art

Mail, parcels, media, freight, express mail, expedited packages and communiques (delivery items) have traditionally required a delivery address that fully describes the physical location of the final destination of the delivery item. These addresses directly relate to the recipient's name, street address/post office box, post office, city, county, state, territory and country of the final destination of the delivery item. Many addresses have a postal code along with the physical address. This postal code may be a “zip code” or other designation. Typically they utilize universally recognized location coordinate systems and notations.

Due to the vast number of potential physical locations in the world a lengthy and complex addressing system was required which could directly address any point on the globe. Even when the location of an entity is well known, such as “The White House, Washington D.C. USA.” a fully qualified address is still required to be applied to the delivery item by the sender.

While comprehensive, this addressing scheme has a number of shortcomings. When an entity, (person or business) moves, their mailing address must change. This means that all their stationary, promotional material, advertisements, web sites, etc. must be modified or replaced to reflect the new address. Customers, friends and family must be notified of the new address before moving. The process for changing one's address is lengthy, complex expensive and time consuming. There is a period of overlap where items may be delivered to the wrong address until all potential senders and the recipient's location are in synchronization again. Even with forwarding to the new address there may be a significant delay. Delivery items still may appear at the old address for years after the recipient has moved because senders may still be using that old address for any variety of reasons. Even moving to a new location in the same building can cause delays because of the minor change in the address.

Due to their length and confluence of unrelated pieces of information, fully qualified addresses are difficult, if not impossible, to remember. They must be written down somewhere for later reference, (the address book or Rolodex), and looked up when needed.

The traditional address is lengthy and complicated, with little information that directly corresponds to the addressee's identity. The rest of the information, (street address, city, state, country, postal code), is of arbitrary relation and not of the choosing or design of the recipient. It does not reflect their preference, choice, corporate brand, trademark or other indicia. Also, the address does not indicate anything directly associated to their identity or business. Nor does it provide them with any marketing value or routing benefit.

One approach to identifiers that is different from the traditional address is the Departments of Motor Vehicles selling “vanity” license plates. Here the license plate identifier is of the customer's formulation, a pneumonic that reflects something of significance to the customer, rather than some arbitrary code number issued by the Motor Vehicles Department to the customer.

### SUMMARY

The system of addressing delivery items has been in existence for a very long time, but it never provided any direct advantages to recipient or sender, other than it's basic function of providing rudimentary targeting coordinates for the delivery agency.

The present invention is directed to an improved addressing method whereby there is relationship between a virtual address, (any unique slogan, phrase, logo, brand, trademark, saying, web address, email address, chat handle, or anything of the customer's choice), and their actual delivery address with a courier or delivery agent. This virtual address would be used in place of a traditional delivery address on the face of a delivery item, and translated to the proper physical address by the shipping agent's database and/or sorting/delivery network. In one embodiment a business or individual may secure a license or right to associate a virtual address with a physical delivery location having a traditional address.

For example, a business called MK Bakery located at 1010 Main Street, Huntington N.Y. would pay a fee to a delivery agent such as the U.S. Postal Service or other agency to deliver any letters and merchandise with the simplified delivery address of “Mary's Cookies”, to them at 1010 Main St, Huntington N.Y. The relationship between this virtual address (“Mary's Cookies”) to the real-world physical street location of the business, (MK Bakery at 1010 Main Street, Huntington N.Y.), would be maintained by the shipper, in this case the U.S. Postal Service, by their delivery/sorting systems, databases and/or networks. The virtual addresses could be read by their optical character readers, or any other technology capable of reading printed text (as they do today with traditional mailing addresses). Customers could simply address mail to “Mary's Cookies” or other virtual address and the sorting equipment would determine the actual physical address for delivery purposes by accessing a database on a computer system where the virtual address is associated with a physical address. The address can be alphanumeric characters, pictures or other symbols or designations selected by a customer.

The present application has benefits not only for the user of a postal system but for the postal or delivery service as well The USPS currently looses several billion dollars a year due to incorrectly addressed mail i.e. “Return to sender”. This mail has to be shipped twice, first to the wrong address and then back to sender for the price of a single stamp. This constitutes at the minimum, a monetary loss. The invention would eliminate this problem as the virtual address would never change when the addressee moves. Also an actual incorrectly addressed virtual address, (no such virtual address) would be caught immediately in the mail flow, local to the sender's address, before expensive air, road or sea shipping costs are incurred.

Another benefit of the invention is a security or privacy feature. The present invention offers subscribers the ability to terminate communications with a party by just eliminating a virtual address they had previously created and issued to the party in question for their private use. This will allow the subscriber to terminate communications with the offending party without having to change their phone number, email address or relocate and notify all other friends, relatives and business associates of their new contact information

### OBJECTS AND ADVANTAGES

Accordingly, several objects and advantages of my invention are a simplified means to address delivery items, simple enough and of sufficient pneumonic significance where full delivery addresses could now be remembered by potential senders (customers) from print, radio and television advertisements without having to write them down.

Other objects and advantages are the ability for an individual or corporation to use their email address, nickname, web site Universal Resource Locator (URL), trademark, or any unique slogan or pneumonic, as their mailing/shipping address, thus extending and strengthening their brand and their corporate identity. Their address can become a marketing tool.

Also an individual person might desire to use their nickname, Instant Messenger handle or any unique identification of their choosing as their postal mailing or shipping address for purposes of novelty or simplicity and ease.

Of particular advantage to both corporations and individuals is the possibility to bring one's online email identify and their physical (actual) mailing identity into alignment. One could use the same address for email and physical shipping items.

Also, if a business or person relocates, their shipping/mailing address can be changed with one simple modification to the virtual address maintained in the shipper/postal administration's sorting/delivery system's database. Since these changes could be distributed worldwide instantly and easily, they could also occur more frequently. It would be feasible to modify one's mailing address while on vacation or on a business trip to their hotel's address, and then back to their home address again when they return from vacation.

In addition, it would no longer be necessary to change or replace stationary, printed advertisements, web sites, promotional material and business cards when a company moves because they utilize the virtual address, which has not changed. Users of this method would no longer have to notify their customer base, or in the case of an individual, their friends and families,that they have a new shipping/mailing address when they move because the virtual address has not changed. They could continue to use the same virtual mailing address, but delivery items would now be routed to the new actual address as defined in the translation database. The address change only occurs in the delivery agent's database.

Also mail and freight could be designed to expire after a given period of time (for promotional campaigns, performance tickets, elections, or any time-sensitive purpose), and rerouted after the given deadline expires. For example, items could be returned to sender after a deadline has elapsed. Or tax returns could be rerouted to a different processing center, (one designated for late returns), after the filing deadline had expired. This is because the actual delivery address can be modified at any time, even after the item has been tendered to a delivery agent because it exists in a database and is not imprinted on the face of the item.

The invention of virtual addressing provides the freight and postal customer with more flexible, dynamic and relevant ways of using shipping and mailing services, which produces clear improvements over prior art.

### DRAWING FIGURES

None

### REFERENCE NUMERALS IN DRAWINGS

None

### DESCRIPTION OF INVENTION

The invention is a process comprised of a “virtual address”, which is composed of some logo, trademark, web address, corporate name, email address, or any unique identifier, which is used as an addressing identifier by anyone who desires to send freight or mail items.

Typically the customer/addressee would define this virtual address as a replacement for their traditional or actual mailing/shipping address (some or all of: recipient name, street address, P.O. box, city/town, county, state, territory, country, mail code, etc.). They would provide both virtual and actual addresses to the shipping agent (typically the postal administration or freight shipper/forwarder).

The shipping agent (postal administration or freight shipper/forwarder) would utilize a translation database that contains the correspondence between all virtual to actual (traditional physical) addresses. Typically, but not necessarily, this translation database would be incorporated into their optical character reader/sorting systems.

Using the virtual address as the database lookup key the system performs a lookup/search to find the actual address where the item should be delivered or routed towards.

For descriptive purposes we might imagine that the scanning/sorting system would apply the actual address to the shipping/mailing item by the application of a delivery bar code identifier. Numerous sorting techniques are possible, but they are not germane to the scope of this invention. The main invention presented here is that the virtual address is used to obtain the actual address from some common translation database, and then the actual address can be used to forward the shipping/mail item on towards its final destination, as is currently the practice using whatever means available.

The virtual mailing/shipping address is used as a shorthand address that represents the physical mailing/shipping address. This business translation method provides all the business benefits and flexibility mentioned in the Objects and Advantages section.

Telephony, Messaging and Email

An alternate implementation of the invention would be in the field of telephony. Most people today utilize multiple telephones, (work, home, cell, car). The telephone number is an “addressing” method to access the device in question. But we do not place telephone calls to communicate with a device but with a person. By utilizing a virtual phone addressing method a person could notify a central management agent or system (telephone company, switching service) of their current or scheduled location so that telephone called placed to any of their telephone numbers or a virtual phone number designed to meet the owner's needs could be routed to the device most readily accessible, or to a phone answering system if privacy is preferred. All their phone numbers could be treated as a virtual communications cluster, and calls placed to any number would be routed to the preferred device.

This scheme would eliminate the need to call several phone numbers in an attempt to eventually locate the individual. One virtual phone number, (or any of their published numbers) could be used to contact the person with a single call. If you receive an answering service/machine you will know it is because the person does not want to be contact at this time. There is no reason to attempt any further calls.

Multiple virtual phone numbers might be utilized to permit special routing depending on customized circumstances. Business callers might use a business virtual phone number and would be routed to office phones and business cell phones only. They would not have access to private or home phones. Phone call routing could be accomplished in advance according to a person's schedule.

The invention also has applications in the field of electronic mail and instant messaging (IM) also. With the proliferation of email there is a tendency to accumulate multiple email addresses. Work networks, home Internet Service Provider, cell phones all provide an email address.

A virtual email and IM addressing system would allow a person to manage their message by routing incoming message traffic to the device that is most convenient for them, typically the device closest to hand. Also by designing their own Vanity-Address the user of the system could issue multiple addresses for various purposes. One of such addresses may be limiting or extending access to different individuals. Work messages may be limited to work related equipment while family related message routing may be extended to all devices (cell phone, car phone, work computer, home computer, etc.).

I claim:

1) A method of delivering items to an address comprising selecting a recipient selected address identifier, providing said selected address identifier to a delivery service, said delivery service associating said selected address identifier with a physical location, said delivery service delivering items with only the recipient selected address identifier to said recipient at said physical location.

2) The method according to claim 1 wherein said items are cargo, freight, postal items and commiques.

3) The method according to claim 1 wherein said recipient address identifier does not correspond to any specific physical location until it is associated by a user with a physical location.

4) The method according to claim 3 wherein when said physical location changes said recipient selected address identifier remains the same.

5) The method according to claim 4 wherein said recipient selected address identifier includes one or more of alphanumeric characters, pictures or other symbols selected by a recipient.

6) The method according to claim 5 further comprising said delivery service inputting said recipient selected address identifier into a computer system, said computer system associating said recipient selected address identifier with an actual physical address, said actual physical address being provided to said delivery service so that said item may be delivered to said recipient at said actual physical address.

7) The method according to claim 6 wherein said actual physical address associated with said recipient selected identifier may change as desired by said recipient.

8) The method according to claim 7 wherein said recipient selected identifier is a trademark of said recipient.

9) the method according to claim 7 wherein said recipient selected identifier is an e-mail address.

10) the method according to claim 7 when said actual physical address associated with a recipient selected address identifier may be altered from a first physical address to a second, actual physical address when a selected period of time has expired.

11) A method of delivery comprising creating a user selected address identifier, associating said user selected address identifier with an actual physical location providing said user selected address identifier and associated actual physical location to a delivery agent, inputting said address identifier and said location into a computer system, providing said delivery agent with an item to be delivered to a physical address, said item bearing said user selected address identifier without said actual physical location, said delivery agent using said user selected address identifier on said item to be delivered to ascertain the actual physical address, delivering said item to said actual physical location.

12) The method according to claim 11 wherein said delivery agent uses a database on said computer system to ascertain an actual, physical location said item is to be delivered to based on the user selected address identifier associated with said actual, physical location.

13) The method according to claim 12 wherein said actual, physical location can be changed by a user prior to delivery by said delivery agent.

14) The method according to claim 12 wherein said user is a recipient of said item.

15) The method according to claim 12 wherein said user is a sender of said item.

16) The method according to claim 12 wherein said delivery agent can change the actual, physical location associated with said user selected address identifier prior to delivery of said item.

17) A method for delivery of time sensitive items comprising addressing said items with a designated address that bears no relation to a physical address, providing a delivery service that is to deliver said item with an actual, physical location for delivery of said item, said actual, physical location being associated with said designated address, changing said actual, physical location associated with said designated address if said item has a delivery date that has expired.

18) The method according to claim 17 further comprising inputting a said designated address into a computer system by a user, said designated address being associated with a physical address, said computer system receiving a delivery deadline associated with said item and wherein said physical address associated with said designated address changes to a new physical address when said delivery deadline is passed.

19) A method of delivering cargo, freight, postal items and communiques comprising:
a. providing an address identifier which is virtual in nature said address identifier not corresponding to any physical location and,
b. said address identifier being defined prior to shipment by a recipient based on parameters defined by said recipient and,
c. translating said address identifier to a actual physical delivery location address
d. delivering the cargo, freight, postal items and communiques to the physical location.
